(19) United States
(12) Patent Application Publication
(10) Pub. No.: US 2006/0154794 A1
(43) Pub. Date: Jul. 13, 2006

(54) Interfolding apparatus with double packer system

(76) Inventors: Dennis P. Couturier, Washburn, WI (US); Greg M. Kauppila, Ashland, WI (US)

Correspondence Address: MICHAEL BEST & FRIEDRICH, LLP, 100 E WISCONSIN AVENUE, MILWAUKEE, WI, 53202, US

(21) Appl. No.: 11/034,671

(22) Filed: Jan. 13, 2005

(51) Int. Cl. B31F 1/08

(52) U.S. Cl. 493/427

(57) ABSTRACT

An interfolding apparatus including first and second interfolding rolls. The interfolding rolls issue a stream of web material to form a stack of interfolded web material. A first packer finger is movable with respect to the first interfolding roll and includes a retracted position at least partially received within the first interfolding roll and an extended position at least partially inserted into the stream of interfolded web material. A second packer finger is movable with respect to the first interfolding roll and includes a retracted position at least partially received within the first interfolding roll and an extended position at least partially inserted into the stream of interfolded web material.

### FIELD OF THE INVENTION

The present invention relates to interfolding apparatuses, and more specifically to packer systems for interfolding apparatuses.

### BACKGROUND OF THE INVENTION

Numerous processes and machines exist to create folds in a stream of web material or in cut sheets issuing from a stream of web material. A typical interfolding apparatus has two rotating interfolding rolls that issue a stream of interfolded web material. One packer finger works in cooperation with each roll to create a fold in the material or sheet.

In operation, separate streams of web material are delivered to individual cutting rolls where the web material is cut into sheets. The sheets then move downward to corresponding interfolding rolls that are positioned to form a nip therebetween. The interfolding rolls rotate in opposite directions and receive the newly-cut sheets of web material from the cutting rolls.

The sheets are usually staggered with respect to the first and second interfolding rolls so that a middle portion of a first sheet of one roll passes through the nip at approximately the same time as leading and trailing edges of sheets of the opposite rolls. At this time, vacuum or mechanical grippers of the first roll grab the center of the first sheet and the leading and trailing edges of the opposing sheets to begin a fold in the first sheet and to capture the leading and trailing edges within the fold.

As the gripper rotates close to the packer finger, the force from the gripper decreases and the packer finger pushes the sheet from the interfolding roll to a position where the fold can be pressed with the leading and trailing edges of the opposing sheets being folded therebetween. This process continues alternately with the other interfolding roll to form a stack of material. In many situations, it is desirable to count out a specific number of sheets for packaging purposes. Additional fingers commonly referred to as count fingers and package building fingers can be used to separate a stack with a desired number of sheets. The count fingers are manipulated into the stack of folded web material at a specific point to define a clip having a known quantity of items.

The prior art systems generally employ the use of one packer finger per roll to create a fold in the stream of web material or sheet of web material. The size and shape of the single packer finger per roll varies in the prior art. The profile of the packer finger as well as the length can determine how much indentation or damage is inflicted on the web material, as well as the quality and location of the fold. The amount of surface area and the length of the packer finger that contacts the web material can contribute toward weakening of the web material as well as incorrect folding.

An advantage of packing the web material with a short packer finger is that the packing force exerted by the short packer finger is applied directly adjacent to the gripper portion of the interfolding roll so that very little force will be applied against the portion of the folded sheet that is upstream of the fold (i.e., the upper panel). However, it is difficult for the short packer finger to create enough friction to properly hold the previously folded sheet in place on the stack of interfolded sheets while the opposite interfolding roll is pulling the upstream portion of the sheet to the other side. If the short packer finger applies greater force on the stack of sheets to hold the previously folded sheet, the web material can be disrupted or damaged. In addition, the short packer finger is unable to properly remove air from the sheets coming off of the rotating rolls when they are being folded thereby allowing air entrapment to potentially cause damage to the sheets being folded at high speeds.

An advantage of creating a fold with a longer packer finger is that the long packer finger can create the right amount of friction to hold the previously folded sheet on the stack of interfolded sheets when the upper portion of the sheet is being tugged down by the opposing interfolding roll to form a fold. Compared to the shorter packer finger, the longer and flatter packer finger generates a larger area of friction force with the same or less force on the stack of sheets. The disadvantage to using the long packer finger is that the long packer finger pushes the sheet of web material at a location that is higher up on the rotating roll when creating a fold. This can cause the sheet of web material to stretch, tear, or become more porous. A longer packer finger provides less control over where the sheet of web material releases from the roll and therefore affects the location of the fold. Also, the longer packer finger transmits more force to the leading edge of the opposing sheet and may cause the leading edge to prematurely release from the gripper on the opposite roll.

In light of the above design limitations, a need exists for a packer finger apparatus that can overcome the limitations of the prior art. A need exists for an interfolding apparatus that has packer fingers that can quickly and precisely fold and pack a stream of web material without causing damage to the sheets. Some embodiments of the invention achieve one or more of these results.

### SUMMARY OF THE INVENTION

In some embodiments, the present invention is directed to an interfolding apparatus that utilizes two packer fingers per rotating roll to create a fold in a stream of web material or in cut sheets issuing from of a stream of web material. The apparatus can include a second packer finger that is longer than a first packer finger to create a dual system of folding the sheets of web material. Using the dual system combines the advantages of a short packer finger as well as the advantages of a long packer finger.

Using a short packer finger to push a cut sheet from the first roll and create a fold is advantageous because the short finger can push the sheet of paper from the interfolding roll at a position very close to the fold to avoid stretching, tearing, or increasing the porosity of the sheet and to create folds at more precise locations. By rounding the portion of the shorter finger contacting the web material, a less detrimental effect on the web material such as marks or indention can be achieved.

By adding the use of a second, longer finger to contact the web material after the first shorter finger has made a fold can help to keep the web taut and push excess air out of the fold thereby reducing air entrapment between the interfolded sheets. The larger finger creates the necessary friction area for holding the previously folded edge against the stack while the opposite side of the interfolding apparatus is creating a fold. Because of the increased friction area, the force exerted by the longer finger onto the stack of sheets does not have to be as great as the force exerted by the short finger, thereby causing less damage to the web material.

One embodiment of the present invention is directed to an interfolding apparatus including first and second interfolding rolls. The interfolding rolls issue a stream of web material to form a stack of interfolded web material. A first packer finger is movable with respect to the first interfolding roll and includes a retracted position at least partially received within the first interfolding roll and an extended position at least partially inserted into the stream of interfolded web material. A second packer finger is movable with respect to the first interfolding roll and includes a retracted position at least partially received within the first interfolding roll and an extended position at least partially inserted into the stream of interfolded web material.

Another embodiment of the invention includes a method of forming a stack of interfolded sheets of web material. The method includes rotating first and second interfolding rolls, issuing a stream of interfolded web material from the first and second interfolding rolls, and forming a stack of interfolded web material. The method also includes moving a first packer finger with respect to the first interfolding roll between a retracted position at least partially received within the first interfolding roll and an extended position at least partially inserted into the stream of interfolded web material. In addition, the method includes moving a second packer finger with respect to the first interfolding roll between a retracted position at least partially received within the first interfolding roll and an extended position at least partially inserted into the stream of interfolded web material.

More information and a better understanding of the present invention can be achieved by referring to the following drawings and detailed description.

### BRIEF DESCRIPTION OF THE DRAWINGS

FIG. 1 is a side view illustrating an interfolding apparatus of one embodiment of the present invention;

FIGS. 2-4 are enlarged side views of a double packer system of the interfolding apparatus shown in FIG. 1; and

FIG. 5 is an enlarged side view of interfolded sheets of the interfolding apparatus shown in FIG. 1.

### DETAILED DESCRIPTION

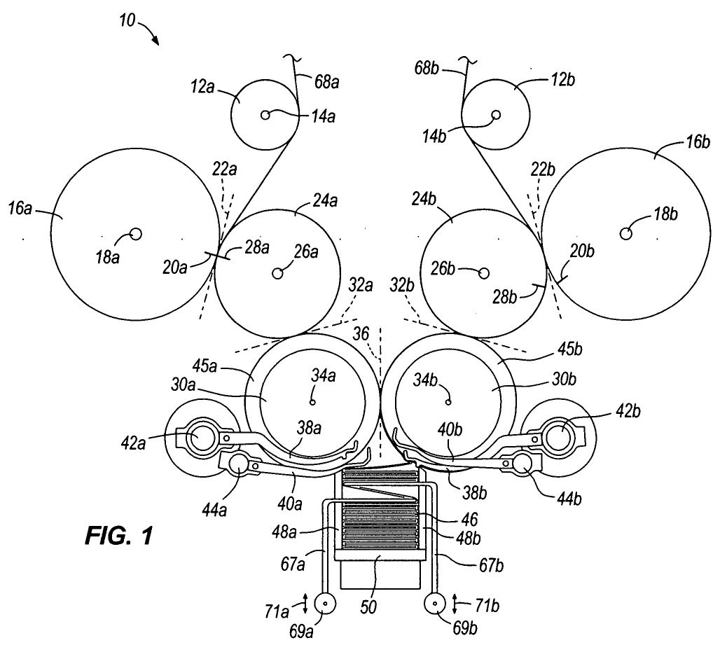

An interfolding apparatus 10 of one embodiment of the present invention is illustrated in FIG. 1. The interfolding apparatus 10 includes two guide rolls 12a, 12b that are mounted for rotation about axes 14a, 14b. Cutting rolls 16a, 16b are mounted for rotation about axes 18a, 18b. Cutting rolls 16a, 16b contain blades 20a, 20b that pass through cutting nips 22a, 22b. Cutting nip 22a is formed between the cutting roll 16a and an opposing cutting roll 24a and cutting nip 22b is formed between the cutting roll 16b and an opposing cutting roll 24b. Cutting rolls 24a; 24b are mounted for rotation about axes 26a, 26b. Cutting rolls 24a, 24b contain anvils 28a, 28b that contact blades 20a, 20b at cutting nips 22a, 22b. The arrangements of the blades 20a, 20b and anvils 28a, 28b are used only as an example. Switching the location of the anvils 28a, 28b and the blades 20a, 20b with one another is also acceptable. An interfolding roll 30a forms a nip 32a with the cutting roll 24a and an interfolding roll 30b forms a nip 32a with the cutting roll 24b. Interfolding roll 30a is mounted for rotation about an axis 34a and interfolding roll 30b is mounted for rotation about an axis 34b. A nip 36 is formed between the interfolding rolls 30a, 30b.

Short packer finger 38a and long packer finger 40a are mounted for pivoting about axes 42a, 44a for movement between retracted positions partially within groove 45a of interfolding roll 30a and extended positions below the interfolding roll 30a and partially within a stream of interfolded sheets 46. Short packer finger 38b and long packer finger 40b are mounted for pivoting about axes 42b, 44b for movement between retracted positions partially within groove 45b of interfolding roll 30b and extended positions below the interfolding roll 30b and partially within the stream of interfolded sheets 46. Cams or servo motors (not shown) can be used to drive the short packer fingers 38b, 38b and long packer fingers 40a, 40b independently of one another. The cams can be driven by timing belts coupled to the interfolding rolls 30a, 30b. The cams can be box cams with profiles that are identical on both sides of the interfolding apparatus 10. The stack of interfolded sheets 46 is supported by guide walls 48a, 48b on the sides and by a base plate 50 from below.

Count fingers 67a, 67b are mounted for rotation about pivots 69a, 69b. Count fingers 67a, 67b are also movable in the vertical direction as indicated by arrows 71a, 71b to be reinserted into the top of the stack of interfolded sheets 46 from a lower position within the stack of interfolded sheets 46. The count fingers 67a, 67b can travel downward within the stack of interfolded sheets 46 as the stack of interfolded sheets 46 move downward with the base plate 50 when the interfolding apparatus 10 is operating. When a specific number of sheets have been folded by packer fingers 38a, 38b, 40a, 40b, one count finger will form the base and one count finger will be at the top of the specific number of sheets, thereby forming a clip. In some embodiments, the count fingers can be used in combination with package building fingers to build and pass the clips. Operation of count fingers is known to one of ordinary skill in the art and therefore is not described in detail in this patent. A more detailed description of the operation of count fingers can be found in U.S. Pat. No. 4,770,402 assigned to C. G. Bretting Manufacturing Company which is incorporated by reference into this application.

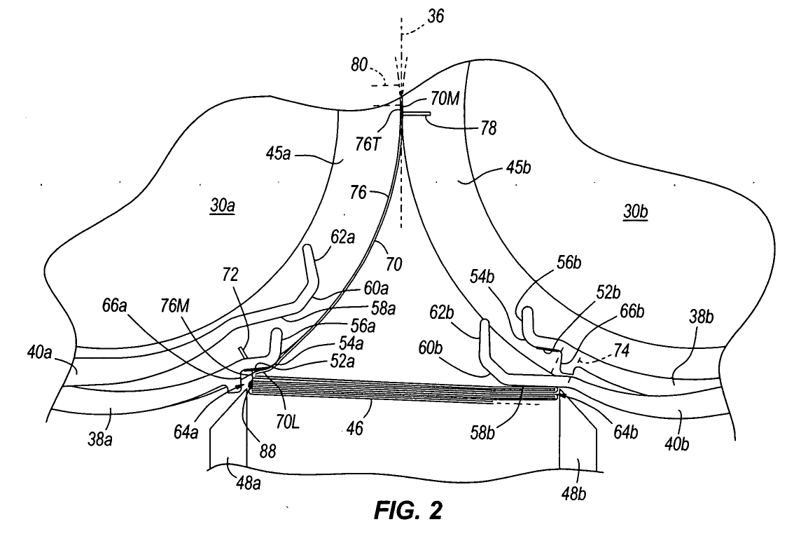

As more clearly shown in FIG. 2, the short packer fingers 38a, 38b have a shape such that the underside of the finger has a short horizontal section 52a, 52b with a curved section 54a, 54b bending into a vertical section 56a, 56b. The long packer fingers 40a, 40b have much longer flat horizontal sections 58a, 58b on the underside of the finger with approximate 45° upward bends 60a, 60b to connect to vertical sections 62a, 62b. Although terms such as “horizontal” and “vertical” are used to describe the illustrated embodiment, it is understood by one with ordinary skill in the art that components and dual packer systems can be used in any orientation and the terms “horizontal” and “vertical” are only relative to the illustration being described. The flat portions 52a, 52b are approximately half the length of the horizontal sections 58a, 58b of the long packer fingers 40a, 40b. In the extended position, the flat portions 52a, 52b contact the stack of interfolded sheets 46 extending from one side edge 64a, 64b (FIG. 2) of the stack of interfolded sheets 46 toward the middle of the stack of interfolded sheets 46. Lower vertical sections 66a, 66b on the short packer fingers 38a, 38b make contact with or nearly make contact with the sides 64a, 64b of the stack of interfolded sheets 46. Also, when the long packer fingers 40a, 40b are in the extended position, the flat portions 58a, 58b contact the stack of interfolded sheets 46 and extend approximately twice as far into the stack of interfolded sheets 46 from the sides 64a, 64b of the stack of interfolded sheets 46 as the flat portions 52a, 52b. The overall length of the long packer fingers 40a, 40b may be the same size as, longer than, or shorter than the short packer fingers 38a, 38b depending on the location of pivots, 42a, 42b, 44a, 44b. However the terms “long” and “short” in reference to packer fingers are directed to the length of the flat portion that is in contact with the stack of interfolded sheets 46. In addition, “long” and “short” fingers can be distinguished by the distance the entire packer finger extends across the stack of sheets from the corresponding side edge 64a, 64b of the stack of sheets 46.

As shown in FIG. 1, the interfolding apparatus 10 is capable of folding and stacking a stream of continuously flowing web material. The interfolding apparatus 10 can be divided into two sides that are mirror images of one another. Therefore, only a first side “a” will be described in detail, with the understanding that a second side “b” performs the same functions, only that the movement is opposite to that of the first side. For example clockwise rotation of a roll on the “a” side would mean that the complementary roll on the “b” side would have counterclockwise rotation.

A stream of web material 68a is issued from a supply roll (not shown) to an inner side of guide roll 12a. Guide roll 12a rotates clockwise about axis 14a and allows the stream of web material 68a to enter the nip 22a between the cutting rolls 16a, 24a. In this embodiment, there is one blade 20a. However, there may be one or more blades 20a on the periphery of the blade cutting roll 16a, depending on the size of the cutting roll 16a, the desired size of the sheets that are to be cut from the stream of web material 68a, or the rotational speed of the cutting roll 16a. Likewise, the number of and positioning of anvils 28a on the cutting roll 24a can vary. The blade 20a serves to cut the stream of web material into a sheet at the point of contact between the cutting rolls 16a, 24a. The stream of web material 68a is transferred to the cutting roll 24a through the use of vacuum ports (not shown) located along the periphery of the cutting roll 24a. When the stream of web material 68a passes through the nip 22a, a cut is made to form a new sheet and the vacuum ports on the cutting roll 24a draw the cut sheet of web material to the outside of the cutting roll 24a. The vacuum port carries the cut sheet to the nip 32a between the interfolding roll 30a and the cutting roll 24a.

Referring to FIG. 2, the details of the folding operation will be discussed making reference to both sides “a” and “b” of the interfolding apparatus 10. As the vacuum port on cutting rolls 24a, 24b bring the cut sheets of web material toward the nips 32a, 32b, the vacuum ports lose suction (i.e., controlled decay of vacuum force) and the sheets are drawn to vacuum ports 74, 80, 84 on the interfolding rolls 30a, 30b. Grippers 72, 78, 86 are located on the periphery of interfolding rolls 30a, 30b in a slightly downstream offset position from the vacuum ports 74, 80, 84 on the opposite roll. The grippers 72, 78, 86 on the interfolding rolls can be either mechanical or vacuum grippers. The gripper 72 on interfolding roll 30a is illustrated after grabbing the leading edge 70L of sheet 70 from the vacuum port 74 while traveling through nip 36. The leading edge 70L of sheet 70 was captured by gripper 72 through a middle portion 76M of sheet 76 with respect to interfolding roll 30a. As FIG. 2 illustrates, the leading edge 70L of sheet 70 is being folded within the middle portion 76M of sheet 76.

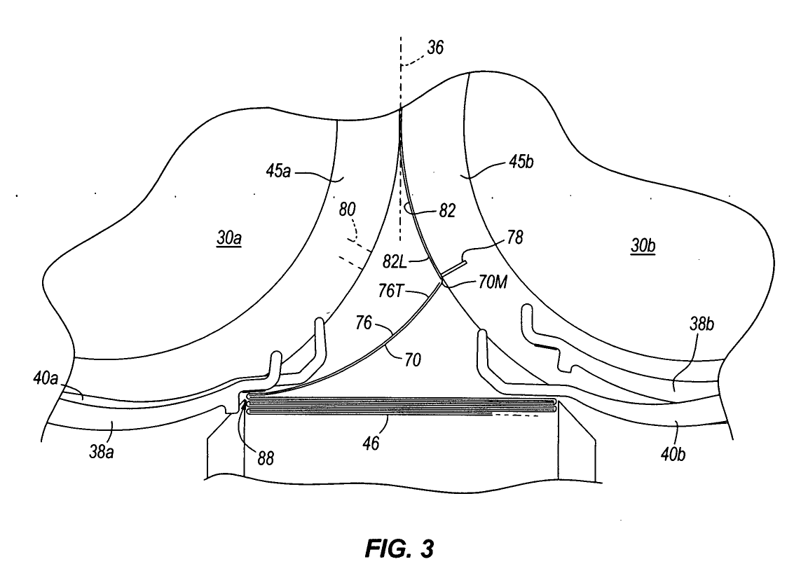

FIG. 2 illustrates gripper 78 adjacent the nip slightly downstream from vacuum port 80. At this position, the gripper 78 grabs the middle portion 70M of sheet 70 as well as a trailing edge 76 T of sheet 76. With reference to FIG. 3, the interfolding rolls 30a, 30b rotate and the vacuum port 80 that once held onto a leading edge 82L of a sheet 82 has weakened enough to allow the gripper 78 to grasp the leading edge 82L of sheet 82, the middle portion 70M of sheet 70, and the trailing edge 76 T of sheet 76.

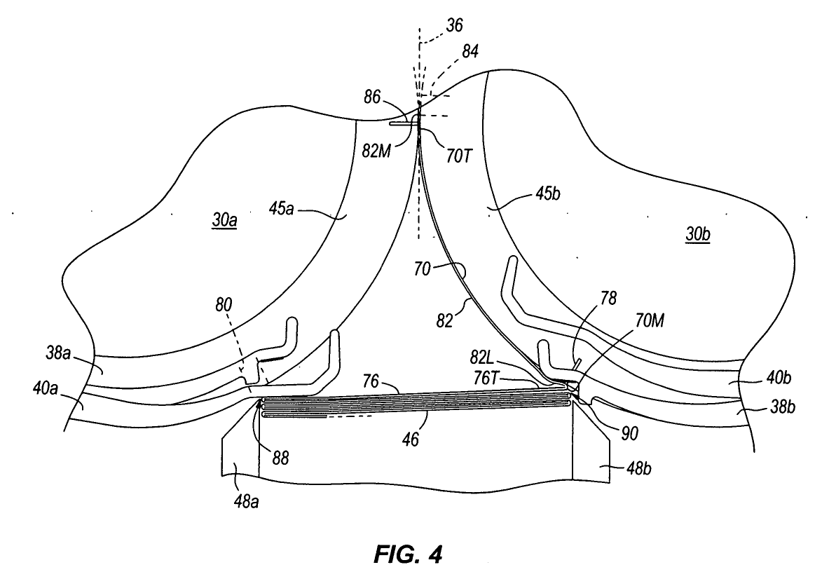

Referring now to FIG. 4, a further stage of rotation of the interfolding rolls 30a, 30b is shown. Gripper 78 has brought the trailing edge 76 T, the middle portion 70M and the leading edge 82L toward guide wall 48b and the stack of interfolded sheets 46. Another vacuum port 84 is shown on interfolding roll 30b along with gripper 86. Gripper 86 will eventually grab the trailing edge 70 T of sheet 70, the middle portion 82M of sheet 82, and the leading edge of a sheet (not shown) immediately following sheet 70 issuing from cutting roll 24b.

Referring back to FIG. 2, a fold 88 forms at the location where the gripper 72 passes by the guide wall 48a and the stack of interfolded sheets 46. The long packer finger 40a on side “a” is in a retracted position within the groove 45a of the interfolding roll 30a while the short packer finger 38a is in an extended position partially extended onto the middle portion 76M of sheet 76 and the leading edge 70L of sheet 70 and the trailing edge of the sheet immediately downstream. On the second side, the long packer finger 40b is fully extended and applies a force onto the stack of interfolded sheets 46. The short packer finger 38b is in a retracted position partially received within the groove 45b of the interfolding roll 30b. The long packer finger 40b is serving to create a frictional force to stabilize the stack of interfolded sheets 46 as the short packer finger 38a is beginning to detach the first sheet 76 and a leading edge 70L of the second sheet 70 from the gripper portion 72.

The short packer finger 38a has a curved profile 54a at the location where the short packer finger 38a contacts the sheets 76, 70 of web material issuing from interfolding roll 30a. The curved profile 54a prevents the short packer finger 38a from causing damage to the sheets 76, 70 of web material when the sheets 76, 70 are being pulled off of the gripper 72 by the short packer finger 38a. The relatively longer flat profile 58a of the long packer finger 40a contacts the stack of interfolded sheets 46 and increases the stability of the stack of interfolded sheets 46. The long horizontal flat profile 58a on the long packer finger 40a increases the surface area acting on the stack 46 and therefore increases the frictional force acting between the long packer finger 40a and the stack of interfolded sheets 46.

As shown in FIG. 1, a distinction can be made between count finger 67a and packer fingers 38a, 40a in that packer fingers 38a, 40a will directly contact every sheet issuing from interfolding roll 30a. In addition, packer fingers 38b, 40b will directly 25 contact every sheet issuing from interfolding roll 30b. Count fingers 67a, 67b will generally only contact a very small percentage of the sheets within the stack depending upon the desired sizes of the clips (e.g. every hundredth sheet).

As shown in FIG. 2, the first sheet 76 has a trailing edge 76 T and sheet 70 has a middle portion 70M. The trailing edge 76 T and the middle portion 70M are held by 30 gripper 78. As interfolding roll 30b rotates, the gripper portion 78 will move toward the guide wall 48b and the stack of interfolded sheets 46.

FIG. 3 shows the progression of rotation of interfolding rolls 30a, 30b. The short packer finger 38a begins to retract away from the stack of interfolded sheets 46 after the fold 88 has been made. The long packer finger 40a is now extending to hold the fold 88 made by the short packer finger 38a and push the entrapped air out of the fold 88 to keep the web taut. On the opposite side, the long packer finger 40b is beginning to retract away from the stack of interfolded sheets 46 while the short packer finger 38b is in a completely retracted position, ready to make the next fold. Gripper 78 is approaching packer fingers 38b, 40b while grabbing the leading edge 82L of sheet 82, the middle portion 70M of sheet 70, and the trailing edge 76 T of sheet 76.

FIG. 4 shows the rotation of interfolding roll 30b as gripper 78 has moved further toward the guide wall 48b and the stack of interfolded sheets 46. The short packer finger 38b extends partially into the sheets 70, 82 of web material to push the sheet 70 away from the gripper 78. The long packer finger 40b is partially retracted within the interfolding roll 30b. The long packer finger 40a is completely extended and creates friction on the first side of the stack of interfolded sheets 46. The long packer finger 40a also provides support and stability along with guide walls 48a, 48b positioned on both sides of the stack of interfolded sheets 46. Similar to the packer finger 38a in FIG. 3, the short packer finger 38b will eventually completely extend to create a fold 90 on the second side of the interfolding apparatus 10. The fold 90 will occur at the middle portion 70M of sheet 70 while capturing the trailing edge 76 T of sheet 76 and the leading edge 82L of sheet 82 within the fold. Through approximately 30° of rotation after the short packer finger 38b is moved to the extended position, the long packer finger 40b assists in bringing the remainder of the sheet 70 and the leading edge 82L of sheet 82 onto the stack of interfolded web material 46. Gripper 86 will begin the process of creating another fold on side “a” above fold 88. The fold will be located at the middle portion 82M of sheet 82 while enfolding the trailing edge 70 T of sheet 70 and the leading edge of the sheet (not shown) directly following sheet 70 on interfolding roll 30b.

In the preferred embodiment, the long packer finger 40a pivots after the short packer finger 28a and after approximately 30° of rotation of the interfolding rolls 30a, 30b. For example, when the short packer finger 38a completely extends and creates a fold on the top of the stack of interfolded sheets 46, the long packer finger 40a is in the retracted position away from the stack of interfolded sheets 46. After 30° of rotation of the interfolding roll 30a, the long packer finger 40a will be fully extended and in contact with the stack of interfolded sheets 46. The specific angle given for the lag of the long packer finger 40a behind the short packer finger 38a is in no way limiting or specific to this invention. Alternate degrees of lag will prove successful, and a 30° angle is solely used as an example.

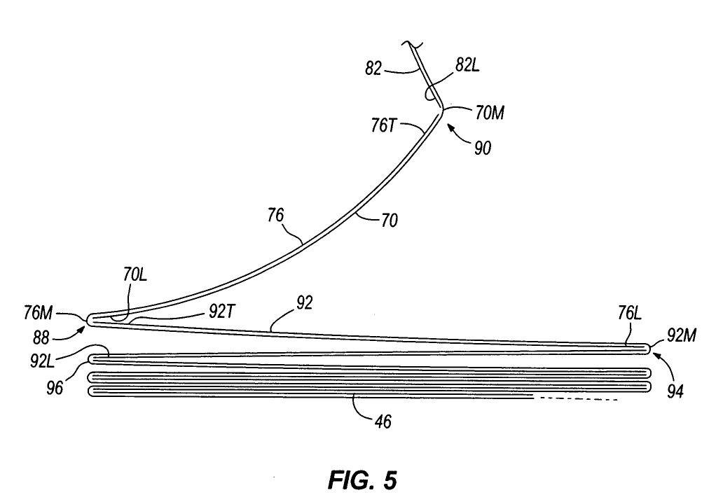

FIG. 5 displays a close-up of the interfolding that occurs between the two separate streams of web material 68a, 68b that have been cut into sheets. A close-up of the interfolded stack of sheets 46 of FIG. 3 is shown. A first sheet 92 has been issued from interfolding roll 30b (not shown) and has trailing edge 92 T captured within fold 88, middle portion 76M creating a fold 94, and leading edge 92L within a fold 96. A second sheet 76 that has been issued from interfolding roll 30a (not shown) has leading edge 76L within fold 94, middle portion 76M creating fold 88, and trailing edge 76 T within a newly forming fold 90. The next sheet 70 issued from interfolding roll 30b has a leading edge 70L within fold 88, a middle portion 70M creating fold 90 and a trailing portion (not shown) that will be on the inside of the next fold. A fourth sheet 82 has a leading edge 82L in fold 90 with the rest of the sheet (not shown) following the pattern established by the first three sheets.

The constructions and aspects described above and illustrated in the drawings are presented by way of example only and are not intended as a limitation upon the concepts and principles of the present invention. As such, it will be appreciated by one having ordinary skill in the art, that various changes in the elements and their configuration and arrangement are possible without departing from the spirit and scope of the present invention as set forth in the claims.

We claim:

1. An interfolding apparatus comprising:
first and second rotating interfolding rolls issuing a stream of interfolded web material to form a stack of interfolded web material;
a first packer finger movable with respect to the first interfolding roll with a retracted position at least partially received within the first interfolding roll and an extended position at least partially inserted into the stream of interfolded web material; and
a second packer finger movable with respect to the first rotating roll with a retracted position at least partially received within the first interfolding roll and an extended position at least partially inserted into the stream of interfolded web material.

2. The interfolding apparatus of claim 1, further comprising:
a third packer finger movable with respect to the second interfolding roll with a retracted position at least partially received within the second interfolding roll and an extended position at least partially inserted into the stream of interfolded web material; and
a fourth packer finger movable with respect to the second rotating roll with a retracted position at least partially received within the second interfolding roll and an extended position at least partially inserted into the stream of interfolded web material.

3. The interfolding apparatus of claim 1, wherein the stream of interfolded web material includes a first sheet drawn by the first interfolding roll, the first sheet having a leading edge and a trailing edge, the first packer finger being movable to the extended position to push the first sheet away from the first interfolding roll and toward the stack of interfolded material to create a fold between the leading and trailing edges.

4. The interfolding apparatus of claim 3, wherein the first packer finger has a curved profile on the portion of the finger that is in contact with the sheet to create a fold.

5. The interfolding apparatus of claim 3, wherein the first sheet includes an upstream panel between the trailing edge and the fold, the second packer finger being movable to the extended position to push the upstream panel away from the first interfolding roll toward the stack of interfolded web material.

6. The interfolding apparatus of claim 5, wherein the first packer finger is shorter than the second packer finger.

7. The interfolding apparatus of claim 5, wherein the second packer finger is moved to the extended position after the first packer finger is moved to the extended position.

8. The interfolding apparatus of claim 5, wherein the stream of interfolded web material includes a second sheet drawn by the second interfolding roll, the second packer finger holding the upstream panel of the first sheet against the stack of interfolded web material while the second sheet is drawn by the second interfolding roll.

9. The interfolding apparatus of claim 8, wherein the leading edge of the second sheet is adjacent to the fold of the first sheet.

10. The interfolding apparatus of claim 8, wherein the second packer finger has a flat portion that holds the upstream panel against the stack of interfolded web material.

11. The interfolding apparatus of claim 1, wherein the first packer finger and the second packer finger rotate about separate pivot axes.

12. The interfolding apparatus of claim 1, wherein the first and second packer fingers move independently of each other.

13. The interfolding apparatus of claim 1, further comprising first and second count fingers mounted for insertion into the stack of interfolded web material.

14. A method of forming a stack of interfolded sheets of web material, the method comprising:
rotating first and second interfolding rolls;
issuing a stream of interfolded web material from the first and second interfolding rolls;
forming a stack of interfolded web material;
moving a first packer finger with respect to the first interfolding roll between a retracted position at least partially received within the first interfolding roll and an extended position at least partially inserted into the stream of interfolded web material; and
moving a second packer finger with respect to the first rotating roll between a retracted position at least partially received within the first interfolding roll and an extended position at least partially inserted into the stream of interfolded web material.

15. The method of claim 14, further comprising:
moving a third packer finger with respect to the second interfolding roll between a retracted position at least partially received within the second interfolding roll and an extended position at least partially inserted into the stream of interfolded web material; and
moving a fourth packer finger with respect to the second rotating roll between a retracted position at least partially received within the second interfolding roll and an extended position at least partially inserted into the stream of interfolded web material.

16. The method of claim 14, further comprising:
drawing a first sheet from the stream of web material to the first interfolding roll;
pushing the first sheet away from the first interfolding roll and toward the stack of interfolded web material by moving the first packer finger to the extended position; and
creating a fold between the leading and trailing edges by moving the first packer finger to the extended position.

17. The method of claim 16, further comprising:
pushing the upstream panel away from the first interfolding roll toward the stack of interfolded web material by moving the first packer finger to the extended position.

18. The method of claim 17, further comprising:
moving the second packer finger to the extended position after the first packer finger is moved to the extended position.

19. The method of claim 17, further comprising:
drawing a second sheet from the stream of web material to the second interfolding roll; and
holding the upstream panel of the first sheet against the stack of interfolded web material while drawing the second sheet to the second interfolding roll.

20. The method of claim 14, further comprising:
moving the first and second packer fingers independently of each other.

21. An interfolding apparatus comprising:
a first rotating interfolding roll conveying a first sheet of web material;
a second rotating interfolding roll conveying a second sheet of web material, the first and second interfolding rolls defining a nip, the first and second rolls rotatable to pass the sheets through the nip and to interfold the sheets to form a stack of interfolded sheets, the second sheet contacting the first sheet and being offset from the first sheet as the sheets pass through the nip;
two packer fingers movable to contact the first sheet; and
an additional two packer fingers movable to contact the second sheet.

22. The interfolding apparatus of claim 21, wherein the first sheet includes a leading edge and a trailing edge, one of the two packer fingers being movable to push the first sheet away from the first interfolding roll and toward the stack of interfolded sheets to create a fold between the leading and trailing edges.

23. The interfolding apparatus of claim 22, wherein one of the two packer fingers has a curved profile on the portion of the finger that contacts the first sheet to create a fold.

24. The interfolding apparatus of claim 22, wherein the first sheet includes an upstream panel between the trailing edge and the fold, the other of the two packer fingers being movable to push the upstream panel away from the first interfolding roll toward the stack of interfolded sheets.

25. The interfolding apparatus of claim 24, wherein the two packer fingers have different lengths.

26. The interfolding apparatus of claim 24, wherein one of the two packer fingers is moved after the other of the two packer fingers is moved.

27. The interfolding apparatus of claim 24, wherein one of the two packer fingers holds the upstream panel of the first sheet against the stack of interfolded sheets while the second sheet is conveyed by the second interfolding roll.

28. The interfolding apparatus of claim 27, wherein the leading edge of the second sheet is adjacent to the fold of the first sheet.

29. The interfolding apparatus of claim 27, wherein at least one of the two packer fingers has a flat portion that holds the upstream panel against the stack of interfolded sheets.

30. The interfolding apparatus of claim 21, wherein the two packer fingers rotate about separate pivot axes.

31. The interfolding apparatus of claim 21, wherein the two packer fingers move independently of each other.

32. The interfolding apparatus of claim 21, further comprising count fingers mounted for insertion into the stack of interfolded web material.

33. A method of forming a stack of interfolded sheets of web material, the method comprising:
rotating a first interfolding roll;
conveying a first sheet of web material with the first interfolding roll;
rotating a second interfolding roll;
conveying a second sheet of web material with the second interfolding roll;
defining a nip between the first and second interfolding rolls;
rotating the first and second rolls to pass the sheets through the nip;
interfolding the sheets to form a stack of interfolded sheets;
contacting the first sheet with the second sheet;
offsetting the second sheet from the first sheet as the sheets pass through the nip;
moving two packer fingers to contact the first sheet; and
moving an additional two packer fingers to contact the second sheet.

34. The method of claim 33, further comprising:
moving one of the two packer fingers to push the first sheet away from the first interfolding roll and toward the stack of interfolded sheets to create a fold between leading and trailing edges of the first sheet.

35. The method of claim 34, further comprising:
moving the other of the two packer fingers to push an upstream panel of the first sheet away from the first interfolding roll toward the stack of interfolded sheets.

36. The method of claim 35, further comprising:
moving one of the two packer fingers after the other of the two packer fingers is moved.

37. The method of claim 35, further comprising:
holding the upstream panel of the first sheet with one of the two packer fingers against the stack of interfolded sheets while conveying the second sheet with the second interfolding roll.

38. The method of claim 37, wherein the leading edge of the second sheet is adjacent to the fold of the first sheet.

39. The method of claim 37, further comprising:
holding the upstream panel against the stack of interfolded sheets with a flat portion of at least one of the packer fingers having a flat portion.

40. The method of claim 33, further comprising:
moving the two packer fingers independently of each other.

41. The method of claim 33, further comprising:
inserting count fingers into the stack of interfolded web material.
